(19) United States
(12) Patent Application Publication
(10) Pub. No.: US 2013/0030590 A1
(43) Pub. Date: Jan. 31, 2013

(54) Peak Mitigation Extension Using Energy Storage and Load Shedding

(71) Applicant: Ronald D. Prosser, Huntington Beach, CA (US)

(72) Inventor: Ronald D. Prosser, Huntington Beach, CA (US)

(73) Assignee: GREEN CHARGE NETWORKS LLC, Huntington Beach, CA (US)

(21) Appl. No.: 13/561,844

(22) Filed: Jul. 30, 2012

Related U.S. Application Data
(60) Provisional application No. 61/513,398, filed on Jul. 29, 2011.

(51) Int. Cl. G06F 1/26

(52) U.S. Cl. 700/295

(57) ABSTRACT

An apparatus and method for managing consumption of electricity of loads at a site which includes energy storage, a system controller, and load shedding ability. The system controller monitors energy consumption of the site and discharges energy into the site when consumption exceeds a maximum consumption threshold. If energy storage is depleted while consumption remains in excess of the threshold the controller may engage load shedding to prevent consumption from exceeding the maximum threshold. Additionally, the energy storage device may recharge during a peak consumption period due to load shedding reducing consumption below the maximum threshold, and the energy storage device may use this recovered energy to further mitigate the peak; in some embodiments, repetitively. Supplemental and additional load mitigation techniques may also be implemented to increase effectiveness and efficiency of the systems and methods.

### CROSS REFERENCE TO RELATED APPLICATIONS

Priority is claimed to the following related pending U.S. Provisional Patent Application, which is hereby incorporated by reference in its entirety: Ser. No. 61/513,398, filed Jul. 29, 2011.

### BACKGROUND

The present invention relates to the field of electrical utility usage mitigation and optimization, the field of electrical utility usage mitigation via peak mitigation by using energy storage and load shedding methods, and related fields.

Electrical energy and power generation and distribution has been a mainstay for residential and commercial energy needs for societies all over the world for many years. Various forms of electrical energy generation have been devised, including coal fired power plants, nuclear power plants, hydroelectric plants, wind harness plants, and others. All of these forms of electrical energy generation are well known to those of skill in the art of power generation and details of their operation need not be set forth herein.

As power generation has advanced, power usage has increased. This is due to many societal factors. First, populations in practically every country of the world have increased, resulting in more power needs. Second, consumer products are frequently designed to use electrical energy in order to operate. Due to advances in technology, more electronic products are available for use today than at any time in world history. Third, manufacturing plants have realized that machine automation can increase plant productivity and decrease production costs. Such automation usually requires electrical energy. Thus, the overall result is a greater need for electrical energy than ever before.

It is also common that energy consumption is greater during certain hours of the day. In any given time zone, electrical energy usage is often greatest during hours of 6 a.m. and 10 p.m., commonly referred to as the “awake hours” or waking hours. Between 10 p.m. and 6 a.m. the next day, most people are using less electrical energy. These hours are commonly called the “sleeping hours.” In order to avoid energy “brownouts” or, worse yet, “blackouts,” power companies have to be able to meet “peak demand” requirements of any given 24 hour day. Peak demand requirements usually occur during the awake hours and historical data obtained from tracking energy usage can fairly accurately predict how much energy will be needed each hour of each day in practically any community. Therefore, peak demand is one of the main drivers of the size and number of power plants needed for any given area. Peak demand drives the sizing and number of feeders, mains, transformers, and other power distribution elements in the grid as well.

The problem with using peak demand requirements to determine power plant capacity is that it does not make for efficient use of the resulting power plant. For example, if a peak demand period in a given area is X kilowatt-hours and that demand is only required for a period of eight hours each day, and the average demand for the rest of the day is half of X, then the design capacity of that power plant for the other sixteen hours of the day is not being effectively utilized. Said another way, if the full energy production capacity of each power plant, for each day, was utilized, fewer power plants would be needed because each one would be fully utilized, all day, every day. Design and usage could then be based on total energy needs each day rather than peak demand needs. Using peak demand requirements also results in an inefficient use of the distribution and transmission systems used by the power plants to deliver the electrical energy they produce.

Another problem with peak demand requirements is the high environmental and financial costs of operating the plants. The power plants that respond to peak demand loads during especially high demand periods of time are frequently more pollutive and expensive to operate than non-peaking power plants. The power companies operating the power plants that wait to supply power for peak demand periods charge a high price to local utilities for their temporary power output. Local utilities then pass the costs of buying power from these peak demand plants to customers as a “demand charge” based on the highest peak draw that the customer takes from the power grid over a billing period. Demand charges are determined differently by various utility providers but tend to be based on the highest usage of electricity (in kW) over a short period of time within a billing cycle. Electricity providers justify these charges by citing the high prices of the peak demand power supply companies and by explaining that they must constantly upgrade and increase capacity of the distribution grid to manage the “spikes” in demand that arise during peak periods.

A consumer's draw on the power grid is, on average, much lower than the power level at which they are rated for demand charges. End users are often unaware of when or how demand charges are accumulated and are displeased to find out that their average electricity consumption is in fact typically much lower than these peaks, and that their power charges would be significantly reduced if their peaks in consumption could be mitigated or eliminated. Environmentally-conscious end users also seek to reduce emissions from the pollutive power plants that provide peaking energy to the grid by decreasing their reliance on them as a power source for peak energy needs.

Load shedding is one method of reducing peaks in consumption. Although it comes in many forms, load shedding is essentially a process wherein loads are temporarily removed from or reduced on a distribution grid at times when energy consumption is high or exceeds an upper limit. The demand imposed on the electrical production systems is thereby temporarily reduced, preventing overloading of the grid and/or excess utility fees and demand charges.

The scope of load shedding varies in nearly every aspect of its various modes of implementation. Early forms of utility-side load shedding involved utility providers mandating customers to shut off power to large electricity-drawing equipment in industrial facilities to prevent plant-overloading blackouts. Load shedding is still used, albeit rarely in the United States, in the form of “rolling blackouts” for this reason. Other types of load shedding include consumer-side load shedding, where a small number of loads at a site or locality are shed during peak periods to minimize demand charges, or very small scale load shedding, where a load is shed in response to a drop in solar power generation output in order to keep critical loads operating. When load shedding is used for peak mitigation, consumers must carefully select the loads to be shed. Lighting, security systems, and electronic doors for example, are critical to operating a facility, but other loads can be temporarily shed with less negative impact, like a music system or television. Some loads such as a refrigerator or HVAC system have ongoing electrical consumption requirements to maintain acceptable conditions, but their consumption needs can be temporarily offset with minimum observable impact but significant reduction in site demand.

### BRIEF SUMMARY

In accordance with one embodiment of the present invention, peak mitigation and load leveling is implemented using energy storage and load shedding elements. For example, at times when power consumption of a site is less than a maximum consumption threshold, energy is stored in an energy storage device, such as, for example, an array of batteries which may be located in or near a structure at the site. In at least some embodiments, the energy stored in the energy storage device comes from the utility grid connected to the site or local energy sources, such as, for example, solar panels. At times when the power consumption of the location exceeds the maximum consumption threshold, energy storage discharges to prevent the consumption read at the utility meter from exceeding the maximum consumption threshold. If the energy storage device discharges completely, or nearly so, then load shedding may be engaged, along with supplemental or additional load mitigation, if desired, to permit the energy storage device to recharge before reactivating to mitigate a peak again. Therefore power consumption is distributed over time, and sustained high power consumption periods that would otherwise result in demand charges or other fees are leveled to approach or match the maximum consumption threshold at the site. These embodiments may allow capacity requirements for a peak mitigating energy storage device at a site to be reduced, and energy stored therein may be allocated to specific loads more easily because load shedding provides some reduction in the need for energy storage to meet peak reduction needs of the site and may therefore allow the energy storage to recharge during peak consumption periods.

Some embodiments implement constant amounts of load shedding and supplemental and/or additional mitigation, and some embodiments allow these measures to vary while shedding and/or mitigation is activated.

Mitigation apparatus or consumption management units (CMUs) may include a system controller and energy storage device, and may include energy generation means, network connectivity, electrical connections to loads at the site, user inputs and outputs, and other components and connections. Loads at the site may receive their power from an output of a CMU and may have sensors that are monitored by a CMU or may not be monitored by sensors connected to the CMU.

Embodiments of the invention may reduce energy consumption charges at a site by reducing or eliminating consumption peaks that would result in demand charges. A site may also become more environmentally friendly with this system installed, reducing the reliance of the site on pollutive peaking plants, reducing energy consumption overall due to load shedding, and may increase awareness of environmental effects of consumption peaking by tracking and potentially displaying information about consumption over time.

In at least one embodiment, a method of mitigating metered consumption of an energy source of a site during a peak in actual consumption of the energy source by loads of the site is presented, comprising reducing actual consumption of a site of an energy source during a peak in energy consumption from the energy source when energy stored by an energy storage system (ESS) configured for mitigating the actual consumption of the site is less than or equal to a peak consumption threshold, and restoring energy to the ESS from the energy source during the peak at a rate less than or equal to the difference between the peak consumption threshold and the reduced actual consumption of the site.

In some embodiments, the method further comprises disengaging the reduction of actual consumption during the peak when the energy level of the ESS is greater than or equal to a restored energy level, and discharging the ESS during the peak at such a rate that the metered consumption does not exceed the peak consumption threshold.

In yet other embodiments, the method further comprises disengaging the reduction of actual consumption during the peak after a predetermined length of time of consumption reduction, and discharging the ESS during the peak at such a rate that the metered consumption does not exceed the peak consumption threshold. In some embodiments, the predetermined length of time is the length of time required for the ESS to recharge to a restored energy level.

In yet other embodiments, the predetermined length of time is the maximum time that a load may be shed. In some embodiments, the maximum time that a load may be shed is determined by comparison of economic value of the load shedding and the peak reduction.

In yet other embodiments, actual consumption is reduced by shedding one or more loads of the site. In some embodiments, one shed load is shed at a different rate than one or more other shed loads. In some embodiments, the loads are controlled to be shed such that the actual consumption is held to follow a specified course.

In yet other embodiments, actual consumption is reduced by energy generation or energy accumulation. In yet other embodiments, the total reduction in energy consumption is prevented from dropping below a predetermined minimum level. In some embodiments, energy is restored to the ESS only when the difference between the peak consumption threshold and the reduced actual consumption of the site is positive. In some embodiments, the energy source is an electrical utility distribution grid. In some embodiments, the energy source is a local generator.

In another embodiment, an energy consumption management method for mitigating peaks in consumption at a site is provided, comprising measuring electrical energy consumed by a load and a site to which the load is connected, detecting energy consumption of the load in excess of a first consumption threshold, supplying energy to the load from an energy source, thereby preventing the energy consumption of the site from exceeding the first consumption threshold due to the load until the level of energy stored in the energy source is less than or equal to a minimum energy stored level, engaging load shedding for the load in such a manner that the energy consumption at the site falls below the first consumption threshold, and charging the energy source during load shedding without the energy consumption at the site incurring an increased demand charge. In some embodiments, the energy consumption at the site does not incur an increased demand charged due to not exceeding a second consumption threshold.

In another embodiment, an apparatus for mitigating peaks of energy consumption is provided, comprising an energy storage system (ESS) having a state of charge, the ESS being configured to discharge to the site and to charge via a connection to a power source, and a system controller configured to monitor energy consumption at the site, control the charging and discharging of the ESS, and engage and disengage load shedding at the site, wherein the controller discharges the ESS when the monitored energy consumption exceeds a maximum consumption threshold, and the controller engages load shedding when the state of charge of the ESS falls below a minimum charge value such that the load shedding allows for the ESS to recharge during the peak without the monitored energy consumption exceeding the maximum consumption threshold.

In some embodiments, the controller disengages load shedding at the site while the ESS discharges. In some embodiments, the controller does not allow energy consumption to drop below a certain level during load shedding. In some embodiments, the ESS has an energy storage capacity that is small enough to completely recharge during a peak while load shedding is engaged and large enough to mitigate a peak in demand while load shedding is disengaged. In some embodiments, the ESS has an energy storage capacity minimized to the energy storage capacity required for the ESS to mitigate a peak in energy consumption while loads recover from being shed.

Additional and alternative features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In addition to the novel features and advantages mentioned above, other objects and advantages of the present invention will be readily apparent from the following descriptions of the drawings and exemplary embodiments, wherein like reference numerals across the several views refer to identical or equivalent features, wherein:

FIG. 1 is a schematic block circuit diagram illustrating components of an embodiment of the present invention;

FIG. 2 is a another schematic block circuit diagram illustrating components of an embodiment of the present invention;

FIG. 3 is yet another schematic block circuit diagram illustrating components of an embodiment of the present invention;

FIG. 4 is graph of energy consumption versus time depicting an exemplary energy consumption curve of a site;

FIG. 5 is a graph of energy consumption versus time according to an embodiment of the present invention with energy storage mitigation represented;

FIG. 6A is a graph of energy consumption versus time according to an embodiment of the present invention with energy storage mitigation and other load mitigation represented;

FIG. 6B is a graph of energy consumption versus time according to an embodiment of the present invention with energy storage mitigation and other load mitigation represented with certain time intervals indicated;

FIG. 6C is a graph of energy consumption versus time according to an embodiment of the present invention with energy storage recharging periods indicated;

FIG. 7 is a graph of energy consumption versus time according to an embodiment of the present invention;

FIG. 8 is a graph of energy consumption versus time according to an embodiment of the present invention with multiple types of load mitigation represented;

FIG. 9 is a graph of energy consumption versus time according to an embodiment of the the present invention with an alternative type of load mitigation represented;

FIG. 10 is a graph of energy consumption versus time according to an embodiment of the present invention with an multiple alternative types of load mitigation represented; and

FIG. 11 is a flowchart showing a peak mitigation process with energy dispensing and load shedding according to an embodiment of the invention.

### DETAILED DESCRIPTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It shall be understood that different aspects of the invention can be appreciated individually, collectively, or in combination with each other.

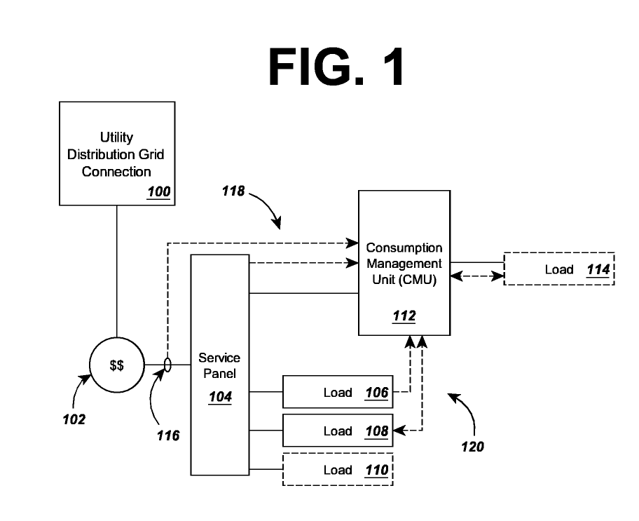

Referring now to the drawings, FIG. 1 shows a schematic block circuit diagram illustrating components of an embodiment of the present invention. At a site, a utility distribution grid connection 100 provides electric power service to the site through a service meter 102 to a service panel 104. Loads 106, 108, 110 are directly connected to the service panel 104, as is a consumption management unit (CMU) 112. An additional load or loads 114 may also receive power by being electrically connected to the service panel 104 through the CMU 112. The CMU is configured to measure current coming from the grid connection 100 at a current measurement point 116, and that reading and a voltage reading from the service panel 104 are both sent 118 to the CMU 112. Some or all of the loads 106, 108, 110, 114 have their energy consumption measured or detected (as shown by the dashed lines 120) by the CMU 112. This system may be used in load shedding and energy storage-assisted load shedding.

Load shedding is a process by which loads such as loads 106, 108, 110, and 114 are dimmed or deactivated to reduce consumption at a site. A load may be “dimmed” by reducing the power draw of the load by changing settings to a power-saving setting, limiting the power provided to the load without preventing power from reaching the load altogether, or another similar practice. Load shedding may be activated at the site by a CMU 112 connected to the loads (e.g., 108, 114), by a user, or by demand-limiting devices and processes on or in the loads. For example, a lighting load may be dimmed in a site by reducing the power provided to the lighting for a period of time by a user, or a large appliance such as a refrigerator may be deactivated for a period of time to reduce the demand of the site when an onboard consumption monitor triggers a load shedding mode. Other loads may be shed by preventing them from turning on, such as preventing a clothing dryer from turning on, or by preventing them from drawing more power than a selected demand limit, such as by preventing the dryer from turning on a heating element during a period of load shedding even though the dryer tumbler may continue to operate.

Load shedding may take place by dimming or deactivating one or many loads at a site depending on the amount of load shedding required and the load that can be shed by each load individually. Ideally, during a period of load shedding at the site, high-consumption devices are limited without a great impact on otherwise normal operations at the site. Load shedding of a refrigerator or HVAC unit, for example, may be a prime option for load shedding as it may drastically reduce demand while its effects may be mostly unnoticeable over short periods of time. More noticeable load shedding such as deactivating all lighting at a site or turning off large production equipment is also considered to be within the scope of the invention, and other methods of load shedding described herein should be considered to be examples of load shedding that may be advantageous to some practitioners of the invention. Because some load shedding is only economically feasible for short periods of time, it is advantageous to have energy storage at the site to “bridge” the site between periods of time when load shedding would be too detrimental. For example, a freezer load may only be shed for a limited time before the cost of a loss of frozen goods would outweigh the cost of paying a demand charge to keep the freezer active, but if energy storage from a CMU is provided to the freezer to keep the goods from perishing during long load shedding periods, the demand charges and the frozen goods may be saved.

The utility distribution grid connection 100 may include a source of electrical energy such as, for example, an electrical connection to an electrical power plant or generator system. The source of electrical energy represented by the utility distribution grid connection 100 may charge the site operator according to the energy drawn from the grid connection 100 at the site or by another method such as by a monthly service charge or similar non-proportional charge. Preferably, the source charges the site operator based on their maximum demand during a billing period as a “demand charge” that can be mitigated by use of a CMU 112.

The utility meter 102 tracks the consumption of energy by the site when it draws energy from the grid connection 100. For example, it may track the kilowatt-hours drawn from the grid connection 100 to loads or the service panel 104 at the site, and may be used to determine the total energy from the grid that is used at the site.

The service panel 104 may be connected to the utility meter 102 and distributes the grid connection 100 to loads 106, 108, 110, and/or 114 or to subpanels that redistribute the electrical connection throughout the site. The service panel 104 connected to the utility meter 102 may be accessible or measureable by a CMU 112 to obtain current and voltage readings 118 for the entire site or a portion of the site. The power line between the utility meter 102 and the main service panel 104 may also be configured for taking a current measurement 116 to obtain the current presently drawn to the site from the utility distribution grid 100. Other features, options, and components of a service panel 104 will be apparent to those skilled in the art.

The loads 106, 108, 110, and 114 may include loads connected to the service panel 104 or to the CMU 112. The loads 106, 108, 110, and 114 may be standard appliances, commercial electrical units, HVAC systems, other user loads, and/or combinations thereof. The loads 106, 108, 110, and 114 may also include any variety of electricity-consuming device that, when connected to the electrical system of the site on the customer side of the service meter 102, draws energy that is charged to the site operator by the utility grid operator. Loads 106, 108, 110, and 114 may also periodically become inactive, thereby not drawing power from the grid connection 100, or may periodically discharge energy into the grid connection 100 or other portions of the site. Loads may be connected to the service panel 104 such as loads 106, 108, and 110, or may be connected to the CMU 112 such as load 114. Either way, the loads may draw electrical energy to operate. If a load 114 is connected through the CMU 112, the CMU may also have the ability to control the amount of power made available to a load 114, and/or whether power is transferred to the load 114 at all. This ability to control the power provided to the load 114 is represented as a solid line between the CMU 112 and the load 114. Loads 106, 108, and 114 may be monitored by the CMU 112, as shown by communication arrows 120. Loads 108 and 114 have a two-sided arrow because the CMU 112 may also be able to issue instructions to those loads, and load 106 may not be able to receive instructions from the CMU 112. Load 110 is shown in dotted lines to indicate that the number of loads may vary, and that some loads may not be monitored or measured by the CMU 112. The loads represented herein are merely representative of various loads that may be connected at the site and at the CMU 112, and should not be interpreted as restrictive of the number of nature of the loads connected in the system according to the invention. The number of loads connected at the site may be one, two, three, four, five, ten, fifty, one hundred, or any other positive integer without departing from the spirit of the invention, and each of these loads may be connected to the CMU 112, service panel 104, or at some other point in the site, and may have differing types and rates of energy consumption and communication (e.g., energy consumption measurements 120) with the CMU 112. It may be preferable to connect some loads to the CMU 112 directly for certain forms of load shedding, and it may be preferable to connect some loads to the service panel 104 or other connections in the site for other forms of load shedding.

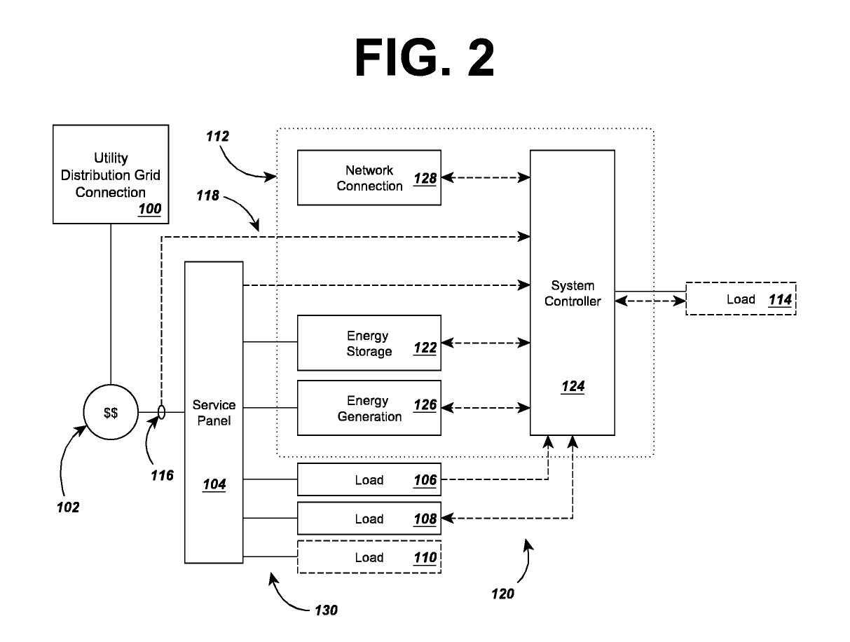

In some embodiments, the consumption management unit (CMU) 112 may include an energy storage device and an electronic controller. It may also include generators, renewable energy generation devices, transmitters, and other electronics. (See also FIG. 2.) The CMU 112 may monitor the energy consumption of a site, such as by taking current and voltage readings 118, and discharge energy into the site when energy consumption at the site exceeds a limit. For instance, the CMU 112 may discharge when a rise or peak in energy consumption would result in the site incurring additional demand charges. In this example, the discharge of energy into the site from the CMU would mitigate the peak as it is observed by the utility meter 102 as if the energy consumed never increased into a demand charge-producing range, even though the combination of energy drawn from the utility distribution grid connection 100 and the CMU 112 is the actual energy consumed by the loads 106, 108, 110, and/or 114. A site may include one or more CMUs 112 to manage demand from different points in the site, or for operational redundancy in cases of emergency.

The current measurement 116 may include current information (e.g., amperage) entering the site from a utility distribution grid connection 100 or entering the site from another portion of the site. A current measurement 116 may be taken using a current transformer (CT), ammeter, or other means for measuring and detecting current in electronics. The current and voltage readings 118 may include current information such as amperage taken from a current measurement 116 and voltage information such as the total voltage at the service panel that is provided to the connected loads (e.g., 106, 108, and 110) and CMU 112. The current and voltage readings 118 may provide sufficient information to the CMU 112 to calculate the total power draw of the site (or some portion of the site monitored). This total power draw may be different from the actual power consumed at the site because the CMU 112 may supply energy to the service panel 104 or loads (e.g., 114), thereby reducing the consumption measured at the utility meter 102 or current measurement 116. With the information from the current and voltage readings 118 the CMU 112 may determine when demand of the site would exceed a peak demand and result in a demand charge.

FIG. 2 is another schematic block circuit diagram illustrating components of an embodiment of the present invention. Namely, the internal components of an example of a consumption management unit (CMU) 112 are shown, including at least one energy storage device 122 and at least one system controller 124, and, optionally, at least one energy generation device 126 and at least one type of network connection 128. The energy storage 122 is shown connected to the service panel 104 to discharge toward the utility grid connection 100 and to recharge via the power supplied by the utility grid connection 100. The system controller 124 is wired and configured to communicate commands to the energy storage 122 and to receive information about the status of the energy storage 122. The energy generation device 126 is connected in the same fashion as the energy storage 122 to the service panel 104 and the system controller 124 so that it can discharge energy to the panel 104 and the controller 124 can monitor the energy generation device's 126 status and control its operation. The network connection connects to the system controller to receive and transmit information through a network. Current and voltage measurements 118 and energy consumption measurements 120 are read by the system controller 124, but it is not necessary that all consumption information is directly detected by the controller 124, as seen by the isolated connection 130 of load 110.

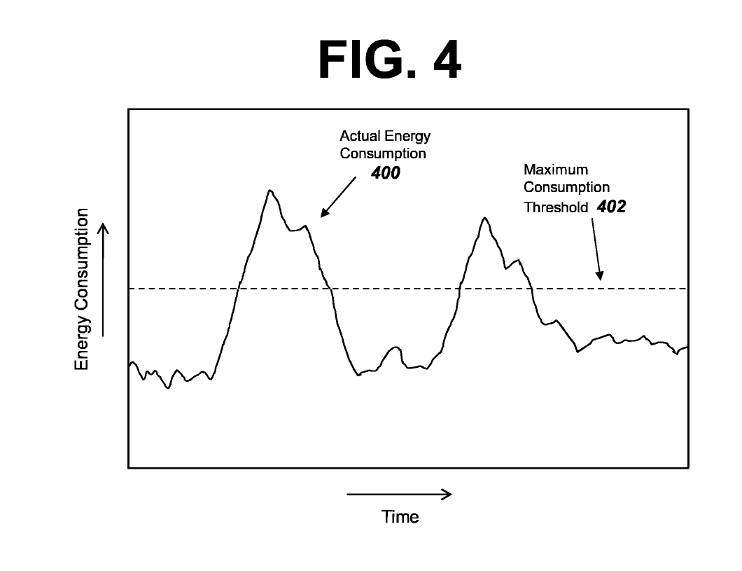

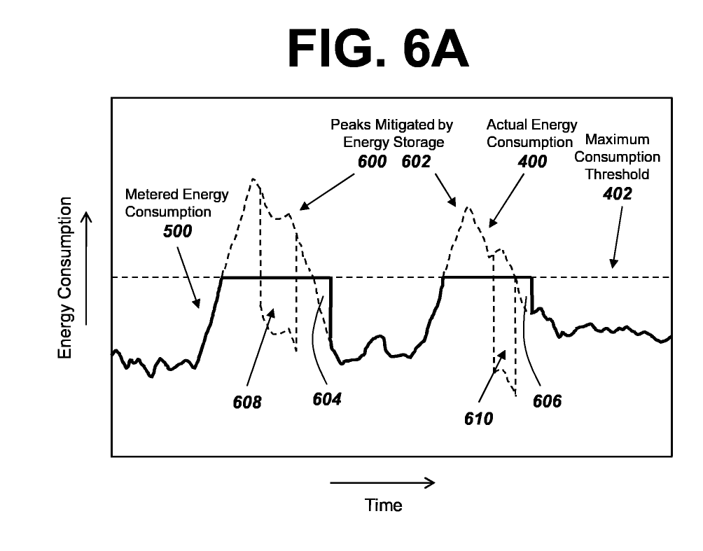

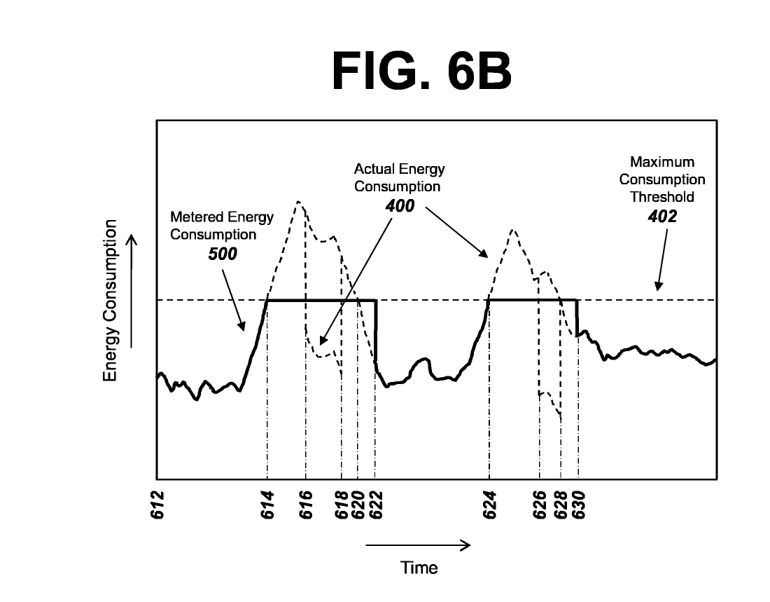

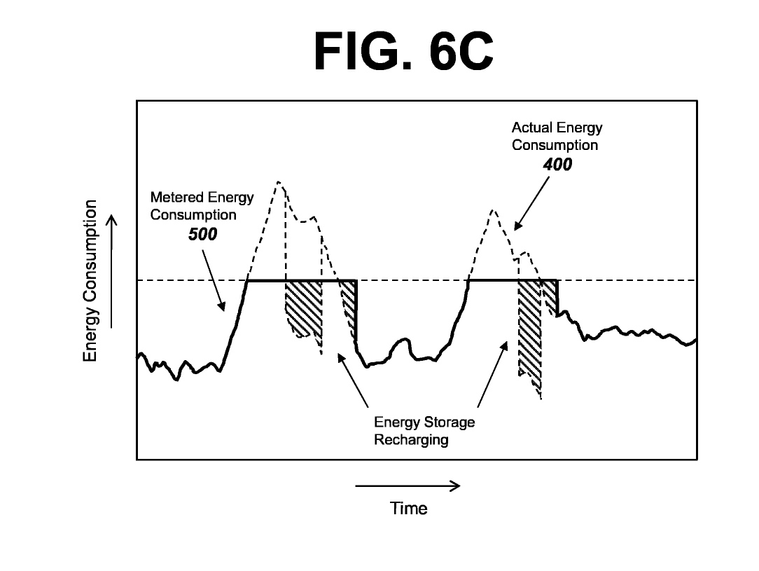

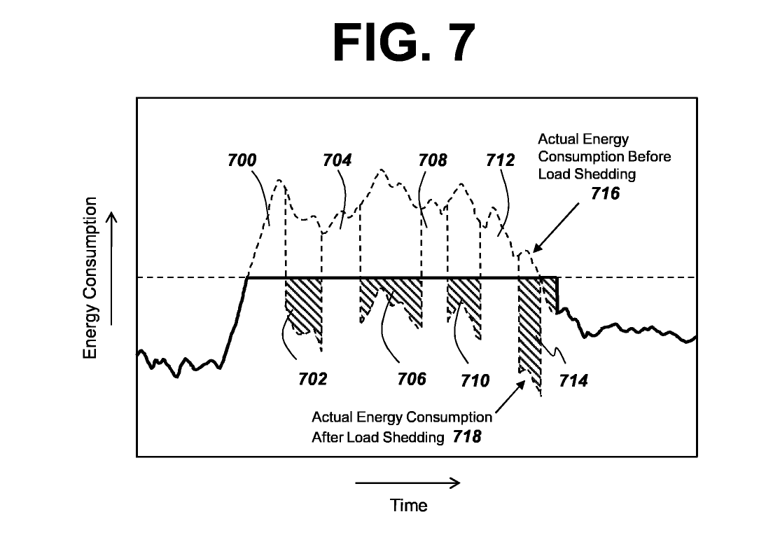

The energy storage device 122 may include batteries, capacitors, fuel cells, flywheels, other energy storing apparatus, and combinations thereof. Energy storage may also include electrical components such as DC-DC converters or inverters to enable the energy storage to interface with the service panel 104 or other portions of the site or CMU 112. Energy storage 112 may include one unit or more than one unit, such as n units, where n is a nonzero positive integer. It may be advantageous to have a large energy storage device 122 in order to mitigate demand spikes for a long period of time. However, according to some embodiments of the invention, the energy storage capacity may be reduced to a point where the energy storage is approximately small enough to substantially or completely recharge while load shedding is enabled over a short period of time and approximately large enough to mitigate peaks in demand while load shedding is disabled in order to prevent losses to the site operator due to engaging load shedding. For example, if the loads shed include refrigerators, the capacity of the energy storage 122 may be minimized by determining the maximum time allowable for the refrigerator loads to be shed and multiplying by the minimum amount of load shedding that brings the average peak values below the maximum consumption threshold (e.g., 402 in FIG. 4). This value may provide the amount of energy that the energy storage requires to recharge between discharges. Meeting this value may be important when peaks are extended and the energy storage 122 must recharge more than one time during mitigation of the peak (see, e.g., FIGS. 6C and 7).

The system controller 124 may include a processor and associated memory of a computer that has inputs and outputs. The controller 124 may have means to monitor the activity of connected loads (e.g., 106, 108, and 114), energy storage 122, energy generation 126, and/or a service panel 104 using devices such as current and voltage sensors at those loads and other assets, and it may interface with other components if necessary. The controller 124 may be a digital signal controller and may have power connections to route power to a load (e.g., 114), and may interface with a network connection 128. The controller may also have an associated memory for permanent or semi-permanent storage of consumption data of the loads and other parts of the site.

In some embodiments the energy generation device 126 may be present in the system to supplement the energy storage 122 in providing energy to the site. The energy generation device 126 may include solar or other photovoltaic panels, wind generators, fuel-based generators, fuel cells, thermoelectric generation, other generating devices, and combinations thereof.

In some embodiments the network connection 128 may include a radio frequency transceiver, a wired connection, or other link to a network. A network may include an intranet or internet of multiple computers, servers, controllers, and combinations thereof. The network connection 128 allows the CMU 112 to send and/or receive instructions and information from external devices, such as to link multiple CMUs 112 to a server that monitors and records energy usage at multiple sites in an area or that may issue discharge commands to the CMUs 112 to push energy into the distribution grid where the CMUs 112 are located. A network connection may include an antenna for communications via wi-fi, radio, cellular, wireless broadband, Bluetooth®, Zigbee®, other wireless standards, and combinations thereof, including those with wired standards.

The isolated connection 130 to load 110 indicated in this figure shows that a load may be connected at the site (e.g., to the service panel 104) in some embodiments such that it is not directly measured by a CMU 112. The consumption of an isolated load 110 may be determined by a CMU 112 by taking current and voltage readings 118 and comparing the power drawn by the site as a whole to the power used by loads that the controller 124 may read, such as loads 106 and 108, then subtracting those loads from the total power used at the site. An isolated load 110 may not be subject to load shedding, or may require external means to shed its electrical consumption.

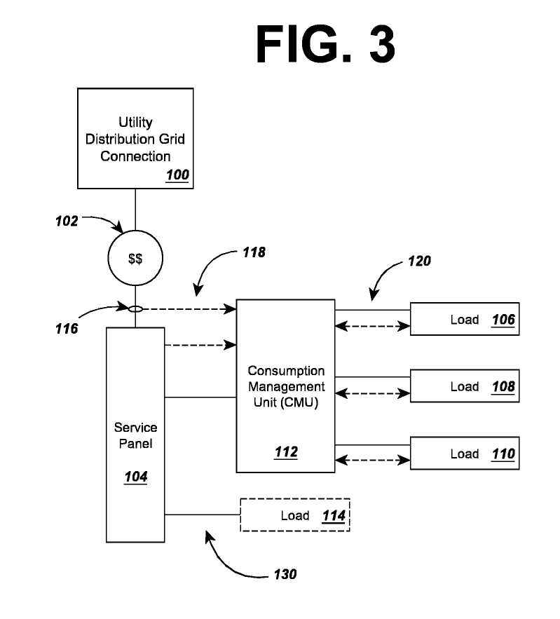

FIG. 3 is yet another schematic block circuit diagram illustrating components of an embodiment of the present invention. Here, the loads 106, 108, 110 receive power through the consumption management unit (CMU) 112. Not all loads must be connected in this manner, however, such as load 114. The configuration of this embodiment may be advantageous in situations where the loads 106, 108, and 110 need to be automatically shed by a program executed by the CMU 112 controller or the loads may be inconvenient to shed without a power transfer control means such as a CMU 112. Each load connected to a CMU 112 may be controlled or shed separately or in groups. In some embodiments, portions of the energy storage of the CMU 112 are used for mitigating peaks caused by certain loads connected and other portions of the energy storage are used for other loads. This may allow an operator to optimize the characteristics of energy storage needed for each load (e.g., capacity, voltage, current, etc.) and more easily upgrade the energy storage if the nature of the loading at the site changes. In yet other embodiments multiple CMUs 112 may be installed at the site to manage different loads or groups of loads, such as, for example, all loads connected to different service subpanels, refrigeration loads only, loads in different structures at the site, or other groups or types of loads.

Embodiments such as those pictured in FIGS. 1, 2, and 3 may be advantageous in that the loads 106, 108, and 110 may be independently monitored, regulated, shed, and mitigated. This may be used where variable load shedding is implemented to cause load shedding to produce a desired actual consumption curve. For example, this may be advantageous in an embodiment where an inverter with a limited rate of energy transfer is used to connect the energy storage of the in the CMU 112 to the site. In this embodiment loads may be shed to keep the actual consumption from exceeding the maximum consumption threshold beyond the inverter's capability to transfer power to mitigate a peak with the energy storage.

FIG. 4 is a graph of energy consumption versus time depicting an exemplary energy consumption curve of a site. The actual energy consumption curve 400 shows the energy consumed at the site by all loads at the site over time, including any energy consumed by maintaining charge in energy storage devices 122, the system controller 124, or other energy consuming elements within or connected to the CMU 112. The dashed line represents a maximum consumption threshold 402 determined by user input or by an optimization algorithm.

The maximum consumption threshold 402 is a value selected as the maximum consumption target for the site. In some embodiments, this value is the maximum consumption level allowed before the site's consumption begins to incur demand charges. In other embodiments, this value is below or above the demand charge threshold, and may be unrelated, such as, for example, a threshold over which an undesired amount of pollution is generated at the site. The maximum consumption threshold 402 may be calculated by the CMU 112 controller, input from a user or external computer, sent to the CMU 112 via a network connection, may be hard-wired into the CMU 112, or may be determined by some other means. It may also vary over time or due to other factors. The maximum consumption threshold 402 may be significant in the operation of embodiments of the invention because it may be the point at which the CMU 112 dispenses energy into the site to mitigate a peak. It may be the point at which the CMU 112 registers that the energy consumption is undesirably high and will dispense energy into the site to bring the energy consumption read at the meter to match or fall below the maximum consumption threshold 402.

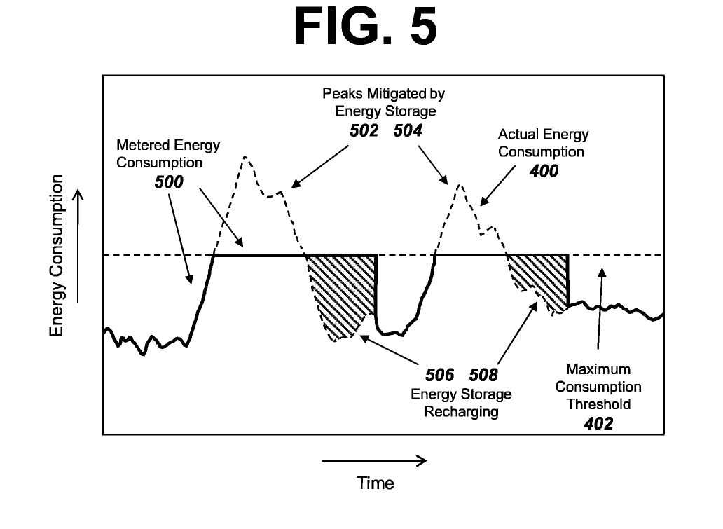

FIG. 5 is a graph of energy consumption versus time according to an embodiment of the present invention with energy storage mitigation represented. The actual energy consumption 400 is not the same as the metered energy consumption 500 in this figure because when the actual energy consumption 400 exceeds the maximum consumption threshold 402, the energy storage device discharges into the electrical system of the site at a rate proportional to the amount that the actual energy consumption 400 exceeds the maximum consumption threshold 402, resulting in a mitigated or “shaved” energy consumption peak (as shown by regions 502 and 504). (In some embodiments, the rate of discharge may be another value, such as a constant rate during a consumption peak.) When actual energy consumption 400 drops below the maximum consumption threshold, the energy storage device recharges (as shown by regions 506 and 508) at a rate equal to the difference between the maximum consumption threshold 402 and the actual energy consumption 400 below the threshold 402 (although lower charging rates could be implemented to complete this function). Once the energy storage device is fully recharged, it stops drawing power from the site and the metered energy consumption curve 500 matches the actual energy consumption curve 400 again.

FIGS. 6A, 6B, and 6C are graphs of energy consumption versus time according to an embodiment of the present invention with energy storage mitigation and load shedding mitigation represented. They show identical energy consumption data but have different labeling. Referring now to FIG. 6A, an actual energy consumption curve 400 has peaks mitigated by energy storage, as shown in regions 600 and 602, resulting in a metered energy consumption curve 500 that does not exceed the maximum consumption threshold 402. Energy storage recharging takes place at least when the actual energy consumption curve 400 is below the maximum consumption threshold 402, as indicated by regions 604 and 606, but these regions 604 and 606 are reduced in size as compared to energy storage recharging regions 506 and 508 in FIG. 5 due to load shedding that takes place in regions 608 and 610. In this and other embodiments, the metered energy consumption curve 500 may exceed the maximum consumption threshold 402 at times but preferably should not do so for a long enough period to exact a higher demand charge for the site. For example, if the demand charge is calculated based on the highest consumption recorded in a billing period during five-minute-averaged blocks of time, the metered energy consumption 500 may exceed the maximum consumption threshold 402 briefly without detrimental impact on the site as long as the five-minute average consumption did not result in a demand charge.

The process illustrated in FIG. 6A is explained in further detail in connection with FIG. 6B. From time 612 to time 614, (a) the actual energy consumption 400 is measured and monitored by the CMU 112 and compared to the maximum consumption threshold 402, (b) the state of charge of the energy storage device is measured and monitored, and (c) the consumption and load requirements of the loads (e.g., 106, 108, and 114) is measured and monitored. If the actual energy consumption 400 is below the maximum threshold 402 and the state of charge (SOC) of the energy storage is less than a predetermined SOC threshold (e.g., 99% SOC), the energy storage is charged using the “headroom” of energy consumption available between the actual energy consumption 400 and maximum consumption threshold 402, such that the energy storage is charged from the grid without causing the actual energy consumption 400 to exceed the maximum threshold 402. If the state of charge of the energy storage satisfies the predetermined SOC threshold the actual energy consumption 400 and the metered energy consumption 500 are the same, as is displayed between time 612 and time 614. At time 614, the actual energy consumption 400 exceeds the maximum consumption threshold 402, so the system controller directs the energy storage to discharge into the electrical system of the site in an amount of power that prevents the metered energy consumption 500 from exceeding the maximum consumption threshold 402. Thus, the metered energy consumption 500 is less than the actual energy consumption 400 at that time. By time 616, the energy storage device has discharged below a lower SOC threshold (e.g., 1% SOC), so the system controller engages load shedding to make the actual energy consumption curve 400 fall below the maximum consumption threshold 402. The load shedding results in “headroom” between the actual energy consumption 400 and the maximum consumption threshold 402, so the energy storage recharges using this available power until it has recharged above the predetermined SOC threshold (e.g., 99% SOC). (See also FIG. 6C.) In the example case of FIG. 6B, the energy storage has completely recharged by time 618, so load shedding is disengaged and the energy storage discharges again to mitigate the peak and result in the metered energy consumption 500 shown. In other embodiments, the energy storage may simply recharge for a certain amount of time, or to regain a certain amount of energy before being directed to start discharging again. At time 620, the actual consumption curve 400 dips below the maximum consumption threshold 402, so the energy storage ceases discharging to mitigate the peak. At time 620 the system controller resumes the monitoring and measuring process described in conjunction with the time between 612 and 614. Namely, since the SOC of the energy storage device is below the predetermined SOC threshold (e.g., 99%), the controller directs the energy storage to begin recharging with the “headroom” available between the curves 400 and 402 until the energy storage has recharged to the predetermined SOC threshold at time 622. At time 622, the battery stops recharging and the actual energy consumption 400 matches the metered energy consumption 500 as the system controller monitors the consumption of the loads and the site in general.

Another peak occurs between time 624 and time 628. The mitigation process is repeated by the system between these times—the energy storage is discharged between time 624 and time 626 until its SOC drops below a lower SOC threshold, and load shedding is engaged (and the energy storage is recharged) between times 626 and 628. In the case of this peak, however, the end of the peak comes before the energy storage device is completely recharged. Thus, the energy storage device does not return to discharging, as it did between times 618 and 620, and instead simply recharges using available headroom from time 628 to time 630. After time 630, the system controller continues monitoring and measuring the energy consumption at the site, and since the actual energy consumption 400 is below the maximum consumption threshold 402, the metered consumption 500 matches the actual energy consumption 400.

FIG. 6C shows the same consumption curves 400 and 500 as FIGS. 6A and 6B with energy storage recharging indicated in the line-patterned areas.

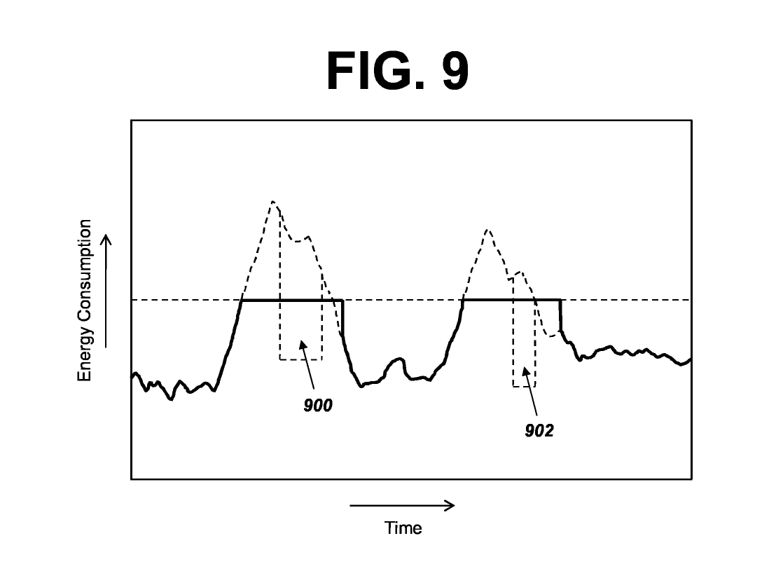

FIG. 7 is a graph of energy consumption versus time according to an embodiment of the present invention. This graph shows how an extended peak or plateau of energy consumption may be mitigated. Region 700 shows the initial discharging of the energy storage device, and when the energy storage device is depleted, load shedding engages so that the energy storage may recharge, as shown in region 702. Likewise, the energy storage device discharges in regions 704, 708, and 712, and recharges in regions 706, 710, and 714. In some embodiments, including the one shown here, the length of time elapsed varies during each of the recharging periods. This may occur because not enough “headroom” is available for the energy storage to quickly recharge. For example, region 706 covers a longer time period than region 702 because it has less available “headroom.” In this embodiment, a set amount of available load shedding is assumed (since the difference between the actual consumption curve before load shedding 716 and the actual consumption curve after load shedding 718 is constant), but, as visualized in FIG. 9, the amount of possible load shedding may be varied, and if that is the case, the elapsed time for each load shedding period can be standardized. Standardizing the length of the load shedding periods may be advantageous to provide more predictability to the downtime or dimmed-time of the loads.

In some embodiments, load shedding periods such as the time periods covering regions 702, 706, 710, and 714 must be managed separate from the metered energy consumption curve 500. For example, if food freezers are the loads shed to permit the energy storage to recharge, then they can only be disabled for a set time period before the cost of the loss of the frozen goods exceeds the cost of increasing the maximum consumption threshold 402. Thus, in these embodiments, as the system controller monitors the energy consumption, it also monitors the costs associated with load shedding and may adjust parameters of the energy management system in order to keep operations cost-effective.

A process and system producing the discharge and load shedding pattern typified by FIG. 7 may greatly reduce the size of an energy storage device needed for peak mitigation—it can be used to mitigate short peaks without causing interruptions produced by load shedding, and in the case of longer peaks, the smaller energy storage system is recharged quickly, even during a peak, to minimize the time required for load shedding over time. When an energy storage system is discharging during the peak, the loads that would otherwise be shed to prevent exceeding a peak consumption threshold can be operational, minimizing downtime of sheddable loads for sites at which uptime of loads that is especially valuable. This characteristic may also allow loads that would otherwise not be considered part of a site's sheddable loads (e.g., freezers, machinery, etc.) to become such since the downtime of the loads is potentially much shorter or more sporadic than loads that are traditionally shed for extended time periods (e.g., HVAC, lighting, etc.).

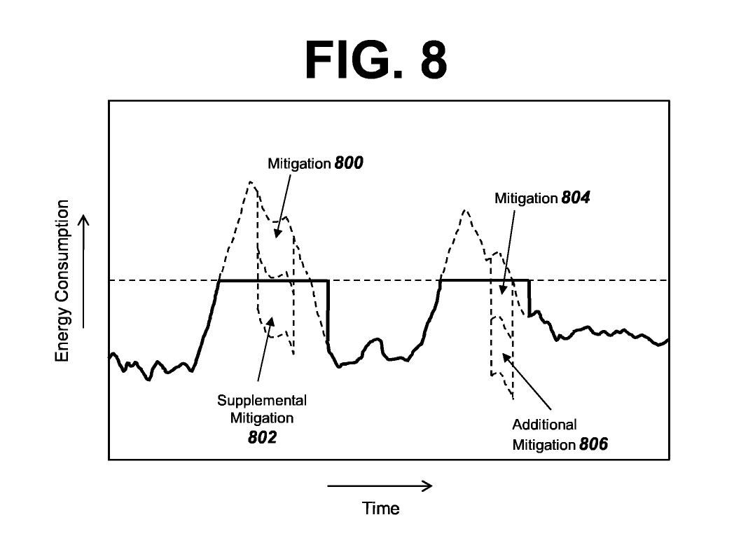

FIG. 8 is a graph of energy consumption versus time according to an embodiment of the present invention with multiple types of simultaneous load mitigation represented. Here, the actual energy consumption curve 400 has its peaks mitigated by an energy storage device as described above when the actual energy consumption curve exceeds the maximum consumption threshold 402, but when the energy storage depletes, load shedding mitigation measures 800 engage as described above. However, in this case the load shedding mitigation 800 does not, at least initially, provide “headroom” for the energy storage device to recharge, and the metered energy consumption curve 500 would rise. Therefore, supplemental mitigation measures 802 are implemented to allow more “headroom” for the energy storage device to recharge. These supplemental mitigation measures 802 can be additional or secondarily-prioritized load shedding loads, activation of energy generation at the site, a backup mitigation energy storage device, or other measures to counteract the load requirements of the actual energy consumption curve 400. Once the energy storage device has recharged, it functions as described above in conjunction with FIG. 6. In some embodiments, additional mitigation measures 806 are not required to provide headroom for the energy storage device to recharge, since load shedding is sufficient mitigation 804 to provide some headroom, but the additional mitigation measures 806 may be implemented anyway to provide extra headroom for the energy storage device to recharge more quickly, to reduce strain on the equipment that is subject to load shedding, or simply because it is more cost effective to use additional mitigation 806 that is not load shedding to mitigate the peak than to mitigate the peak using load shedding alone. For example, if the system is implemented in a swimwear store and a room heater is used as the load shed by the controller, it may be more beneficial to the site to turn on a propane generator to mitigate a peak in conjunction with shedding the heater load, thereby reducing the time the heater load is shed, than it is to shed the heater load alone for a prolonged period of time and thereby exposing the customers to low temperatures. Typically, the additional mitigation comes from energy generation or a backup energy storage device, but any other means of providing mitigation or offsetting loads may be used in these embodiments. Alternatively, in some embodiments the mitigation 800 is due to generators, backup energy storage, and other mitigation measures described in relation to the supplemental mitigation 802 above, and the supplemental mitigation 802 is due to load shedding alone. In some embodiments, multiple tiers of sheddable loads are used in this manner to tailor the amount of load shedding implemented to the size of the peak recorded.

FIG. 9 is a graph of energy consumption versus time according to an embodiment of the present invention with an alternative type of load mitigation represented. Here, the peaks in the actual energy consumption curve 400 are mitigated as described generally above, but when the energy storage device is depleted, the load shedding is limited to produce an actual energy consumption of a specific value and does not take place at a consistent rate (as seen by the varied difference between the actual energy consumption curve before load shedding and the actual energy consumption curve after load shedding). Thus, the “headroom” provided to the energy storage device to recharge is consistent across the entire period of time that load shedding takes place, as shown by shape of regions 900 and 902. This embodiment may be beneficial by providing more predictability in the length of time that loads will need to be shed, since the energy storage device will recharge in roughly the same amount of time whenever it is depleted. Regions 900 and 902 have different levels of load shedding, as shown by the increased amount of headroom provided in region 902 as compared to 900, but in some embodiments would be preferable to provide the same amount of headroom in both instances.

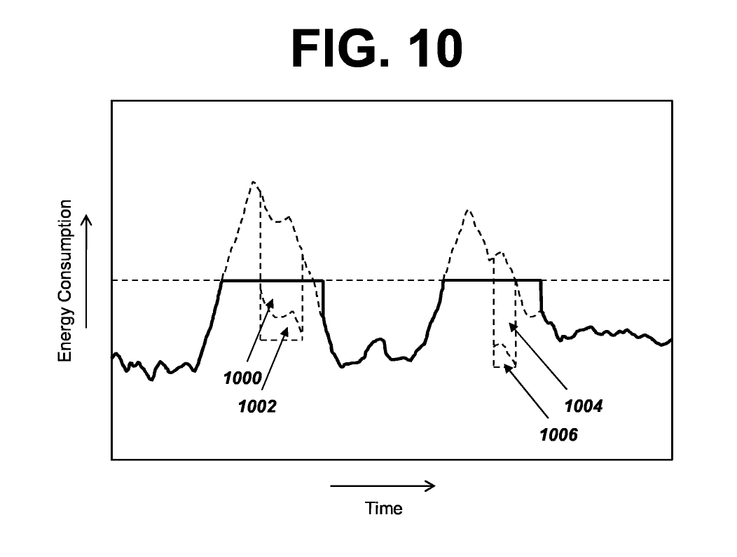

In these embodiments, such as shown in FIG. 10, the load shedding may vary over the load shedding time period, or the load shedding may be constant while supplemental or additional mitigation (such as is shown, for example, in FIG. 8) varies over time. For example, regions 1000 and 1004 may represent constant load shedding and regions 1002 and 1006 may represent additional mitigation that is variable, or regions 1000 and 1004 may represent constant additional mitigation and regions 1002 and 1006 may represent variable load shedding. In some embodiments, different loads are shed at different levels or rates so that some loads are mitigated more heavily, e.g., for a longer period of time or more power is cut off at once, or at different ranges, e.g., at different levels over time.

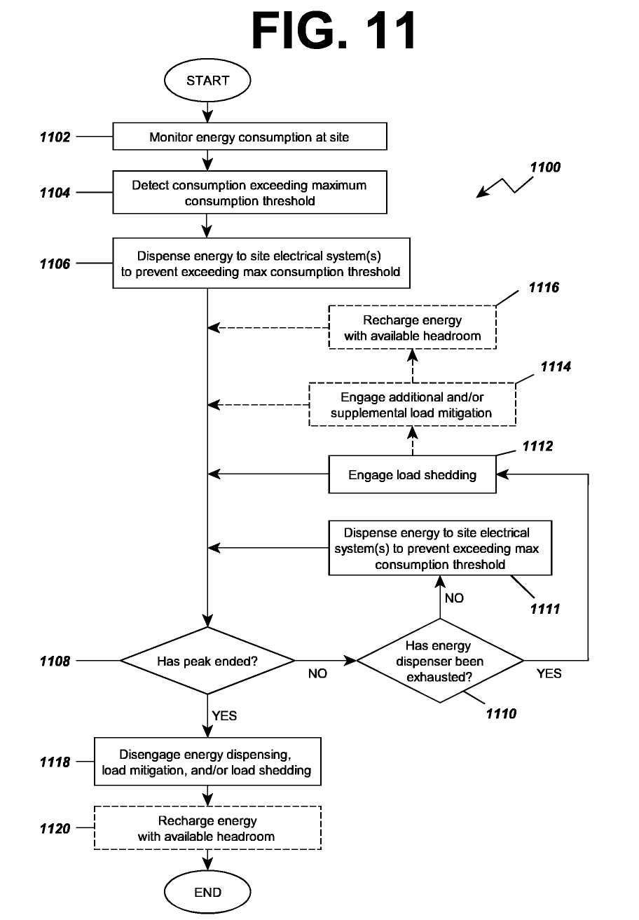

FIG. 11 is a flowchart showing a peak mitigation process 1100 with energy dispensing and load shedding according to an embodiment of the invention. The process begins and energy consumption of a site is monitored at step 1102. Next, consumption is detected exceeding a maximum consumption threshold at step 1104. Energy is then dispensed to an electrical system or systems at the site to prevent the consumption from exceeding the maximum consumption threshold in step 1106. The energy may be dispensed from an energy dispenser such as an energy storage device, generator, or combination thereof connected to the site. In the case of an energy storage device, the energy dispenser may be able to recharge using a power connection to the site. A CMU of other embodiments may be connected as an energy dispenser and/or energy consumption monitor according to this embodiment. Next, there is a check to see if the peak has ended in step 1108. If the peak has not ended, the process checks to see if the energy dispenser has been exhausted 1110. Energy exhaustion of an energy dispenser may include complete depletion of the energy store or a drop in output or capacity to a level below a threshold. If energy of the CMU is not exhausted, energy continues to be dispensed into the system(s) at step 1111 and the process repeats step 1108. If energy is exhausted in the check at step 1110, load shedding is engaged at step 1112, reducing consumption at the site, and check 1108 may repeat. If possible, the system may also engage additional and/or supplemental mitigation in step 1114 instead of immediately returning to check 1108, and if the energy is rechargeable, it may also be recharged at step 1116 using available headroom resulting from the implementation of steps 1112 and 1114 before returning to check 1108. In some embodiments steps 1114 and 1116 may be skipped collectively or individually and the process may then return to check 1108. The amount of recharging in step 1116 may be full recharging or partial recharging, depending on the implementation of the embodiment. Once the check at 1108 indicates that the peak has ended and consumption of the site has fallen below the maximum consumption threshold, the process disengages any active energy dispensing, load mitigation, and/or load shedding in step 1118 and may recharge the energy dispensed with headroom energy available between the actual consumption level of the site and the maximum consumption threshold in step 1120. The process 1100 then ends or may repeat from the start.

Some methods and systems of the embodiments of the invention disclosed herein may also be embodied as a computer-readable medium containing instructions to complete those methods or implement those systems. The term “computer-readable medium” as used herein includes not only a single physical medium or single type of medium, but also a combination of one or more tangible physical media and/or types of media. Examples of a computer-readable medium include, but are not limited to, one or more memory chips, hard drives, optical discs (such as CDs or DVDs), magnetic discs, and magnetic tape drives. A computer-readable medium may be considered part of a larger device or it may be itself removable from the device. For example, a commonly-used computer-readable medium is a universal serial bus (USB) memory stick that interfaces with a USB port of a device. A computer-readable medium may store computer-readable instructions (e.g. software) and/or computer-readable data (i.e., information that may or may not be executable). In the present example, a computer-readable medium (such as memory) may be included to store instructions for the charging, discharging, and load shedding by the controller or to control it to perform other actions and processes disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

In addition, it should be understood that the figures described above, which highlight the functionality and advantages of the present invention, are presented for example purposes only and not for limitation. The exemplary architecture of the present invention is sufficiently flexible and configurable, such that it may be utilized in ways other than that shown in the figures. It will be apparent to one of skill in the art how alternative functional, logical or physical partitioning, and configurations can be implemented to produce or implement the desired features of the present invention. Also, a multitude of different constituent module or step names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in multiple various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments. The invention is also defined in the following claims.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “typical,” “conventional,” “traditional,” “normal,” “standard,” “known” and terms of similar meaning should not be construed as limiting the time described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise or context dictates otherwise. Similarly, a group of items linked with the conjunction “or” should not be read as requiring mutual exclusivity among that group, but rather should also be read as “and/or” unless expressly stated or context dictates otherwise. Furthermore, although items, elements or component of the invention may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Additionally, the various embodiments set forth herein are described in terms of exemplary block diagrams and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

Further, the purpose of the Abstract is to enable the U.S. Patent and Trademark Office and the public generally, and especially the scientists, engineers, and practitioners in the art who are not familiar with patent or legal terms or phraseology to determine quickly from a cursory inspection the nature and essence of the technical disclosure of the application. The Abstract is not intended to be limiting as to the scope of the present invention in any way.

What is claimed is:

1. A method of mitigating metered consumption of an energy source of a site during a peak in actual consumption of the energy source by loads of the site, the method comprising:
reducing actual consumption of a site of an energy source during a peak in energy consumption from the energy source when energy stored by an energy storage system (ES S) configured for mitigating the actual consumption of the peak drops below a minimum energy level such that the actual consumption of the site is less than or equal to a peak consumption threshold; and
restoring energy to the ESS from the energy source during the peak at a rate less than or equal to the difference between the peak consumption threshold and the reduced actual consumption of the site.

2. The method of claim 1, further comprising:
disengaging the reduction of actual consumption during the peak when the energy level of the ESS is greater than or equal to a restored energy level; and
discharging the ESS during the peak at such a rate that the metered consumption does not exceed the peak consumption threshold.

3. The method of claim 1, further comprising:
disengaging the reduction of actual consumption during the peak after a predetermined length of time of consumption reduction; and
discharging the ESS during the peak at such a rate that the metered consumption does not exceed the peak consumption threshold.

4. The method of claim 3, wherein the predetermined length of time is the length of time required for the ESS to recharge to a restored energy level.

5. The method of claim 3, wherein the predetermined length of time is the maximum time that a load may be shed.

6. The method of claim 5, wherein the maximum time that a load may be shed is determined by comparison of economic value of the load shedding and the peak reduction.

7. The method of claim 1 wherein actual consumption is reduced by shedding one or more loads of the site.

8. The method of claim 7, wherein one shed load is shed at a different rate than one or more other shed loads.

9. The method of claim 7, wherein the loads are controlled to be shed such that the actual consumption is held to follow a specified course.

10. The method of claim 1, wherein actual consumption is reduced by energy generation or energy accumulation.

11. The method of claim 1, wherein the total reduction in energy consumption is prevented from dropping below a predetermined minimum level.

12. The method of claim 1, wherein energy is restored to the ESS only when the difference between the peak consumption threshold and the reduced actual consumption of the site is positive.

13. The method of claim 1, wherein the energy source comprises an electrical utility distribution grid.

14. An energy consumption management method for mitigating peaks in consumption at a site comprising:
measuring electrical energy consumed by a load and a site to which the load is connected;
detecting energy consumption of the load in excess of a first consumption threshold;
supplying energy to the load from an energy source, thereby preventing the energy consumption of the site from exceeding the first consumption threshold due to the load until the level of energy stored in the energy source is less than or equal to a minimum energy stored level;
engaging load shedding for the load in such a manner that that the energy consumption at the site falls below the first consumption threshold; and
charging the energy source during load shedding without the energy consumption at the site incurring an increased demand charge.

15. The method of claim 14, wherein the energy consumption at the site does not incur an increased demand charge due to not exceeding a second consumption threshold.

16. An apparatus for mitigating peaks of energy consumption, comprising:
an energy storage system (ESS) having a state of charge, the ESS being configured to discharge to the site and to charge via a connection to a power source; and
a system controller configured to monitor energy consumption at the site, control the charging and discharging of the ESS, and engage and disengage load shedding at the site, wherein the controller discharges the ESS when the monitored energy consumption exceeds a maximum consumption threshold, and the controller engages load shedding when the state of charge of the ESS falls below a minimum charge value such that the load shedding allows for the ESS to recharge during the peak without the monitored energy consumption exceeding the maximum consumption threshold.

17. The apparatus for mitigating peaks of energy consumption of claim 16, wherein the controller disengages load shedding at the site while the ESS discharges.

18. The apparatus for mitigating peaks of energy consumption of claim 16, wherein the controller does not allow energy consumption to drop below a certain level during load shedding.

19. The apparatus for mitigating peaks of energy consumption of claim 16, wherein the ESS has an energy storage capacity that is small enough to completely recharge during a peak while load shedding is engaged and large enough to mitigate a peak in demand while load shedding is disengaged.

20. The apparatus for mitigating peaks of energy consumption of claim 16, wherein the ESS has an energy storage capacity minimized to the energy storage capacity required for the ESS to mitigate a peak in energy consumption while loads recover from being shed.
